(19) United States
(12) Patent Application Publication
(10) Pub. No.: US 2021/0271096 A1
(43) Pub. Date: Sep. 2, 2021

(54) OPTICAL PATH CONTROL MEMBER AND DISPLAY DEVICE COMPRISING SAME

(71) Applicant: LG INNOTEK CO., LTD., Seoul (KR)

(72) Inventors: Hyun Joon KIM, Seoul (KR); Hyun Dong CHO, Seoul (KR); Kwang Ho PARK, Seoul (KR); Sung Gon JUN, Seoul (KR); Dong Woo SOHN, Seoul (KR)

(21) Appl. No.: 17/258,847

(22) PCT Filed: Jul. 15, 2019
(86) PCT No.: PCT/KR2019/008711

§ 371 Date: Jan. 8, 2021

(30) Foreign Application Priority Data
Jul. 27, 2018 (KR) 10-2018-0087663
Aug. 9, 2018 (KR) 10-2018-0093176
Aug. 14, 2018 (KR) 10-2018-0095169
Sep. 3, 2018 (KR) 10-2018-0104507

(51) Int. Cl. G02B 27/09; G02B 27/60; B32B 3/30

(52) U.S. Cl. CPC G02B 27/095; G02B 27/60; B32B 2307/42; B32B 2457/20; B32B 3/30

(57) ABSTRACT

An optical path control member according to an embodiment comprises: a base substrate; a resin layer disposed on the base substrate and including a plurality of engraved parts spaced from each other; and a plurality of pattern parts disposed inside the plurality of engraved parts and spaced from each other, wherein each of the pattern parts comprises a first light shielding layer and a second light shielding layer disposed on the first light shielding layer, the height of the first light shielding layer is higher than the height of the second light shielding layer, and the overall height of each of the pattern parts is less than or equal to the overall height of the engraved parts and greater than or equal to 93% of the height of the engraved parts.

### TECHNICAL FIELD

Embodiments relate to an optical path control member and a display device including the same.

### BACKGROUND ART

A light shielding film shields transmitting of light from a light source, and is attached to the front surface of a display panel which is a display device used for a mobile phone, a notebook, a tablet PC, a vehicle navigation system, a vehicle touch, etc., so that the light shielding film adjusts a viewing angle of light according to an incident angle of light to express a clear image quality at a viewing angle needed by a user when the display transmits a screen.

In addition, the light shielding film may be used for the window of a vehicle, building or the like to shield outside light partially to prevent glare, or to prevent the inside from being visible from the outside.

That is, the light shielding film may control the movement path of light, shield light in a specific direction, and transmit light in a specific direction.

Meanwhile, such a light shielding film may be applied to a display device such as a navigation system or a vehicle dashboard in a movement means such as a vehicle. That is, the light shielding film may be applied to various fields in accordance with various purposes.

Meanwhile, in order to control the movement path of light, a plurality of patterns for converting a path of light may be formed on a transparent substrate in the light shielding film.

Such patterns may block light emitted from a light source. That is, the light shielding film is disposed on a display panel including the light source, blocks light in a region in which the pattern is disposed, transmits light in a region in which the pattern is not disposed, and may serve to make light visible only at a certain viewing angle.

Each of such patterns may be formed by filling the inside of an engraved portion with a light shielding material. At this time, since the light shielding material is formed while partially filling the inside of the engraved portion, the overall light blocking effect of an optical path control member may be reduced.

In addition, since a thickness of each of the pattern portions is different from each other, a deviation of the thickness of each of the pattern portions is increased, and accordingly, there is a problem that a deviation of a light blocking rate is generated in each region to generate spots or the like.

In addition, different amounts of light may be transmitted depending on each viewing angle. At this time, when an amount of transmitted light is small, the overall brightness may be reduced and a user's visibility may be reduced.

Therefore, there is a need for an optical path control member having a new structure capable of increasing light transmittance and improving brightness while visually recognizing light only at a certain viewing angle.

### DISCLOSURE

### Technical Problem

The embodiment is directed to providing an optical path control member having an improved light blocking effect and brightness uniformity.

In addition, the embodiment is directed to providing an optical path control member capable of improving front brightness.

### Technical Solution

An optical path control member according to an embodiment includes: a base substrate; a resin layer disposed on the base substrate and including a plurality of engraved portions spaced apart from each other; and a plurality of pattern portions disposed inside the plurality of engraved portions and spaced apart from each other, wherein each pattern portion includes a first light shielding layer and a second light shielding layer disposed on the first light shielding layer, a height of the first light shielding layer is larger than a height of the second light shielding layer, and a total height of each pattern portion is equal to or less than a total height of the engraved portion, and is 93% or more of a height of the engraved portion.

An optical path control member according to an embodiment includes: a base substrate; a resin layer including a plurality of engraved portions disposed on the base substrate and spaced apart from each other; and a plurality of pattern portions disposed inside the plurality of engraved portions and spaced from each other, wherein the optical path control member satisfies Equation 1 and Equation 2 below.

Second distance/(First distance+Second distance)≥0.75 [Equation 1]

Second distance/Third distance<0.32 [Equation 2]

(At this time, the first distance is the width of each pattern portion, the second distance is the distance between the pattern portions, and the third distance is the height of each pattern portion.)

An optical path control member according to an embodiment includes: a base substrate; a resin layer disposed on the base substrate and including a plurality of engraved portions and a plurality of embossed portions spaced apart from each other; and a plurality of pattern portions disposed inside the plurality of engraved portions and spaced apart from each other, wherein the pattern portion blocks light, and the embossed portion transmits light, a refractive index of the embossed portion is larger than a refractive index of the pattern portion, the refractive index of the embossed portion is 1.54 to 1.64, a difference between the refractive index of the embossed portion and the refractive index of the pattern portion is 0.16 or less, and a critical angle at an interface between the pattern portion and the embossed portion is 63° to 79°.

### Advantageous Effects

An optical path control member according to an embodiment may form a pattern portion disposed inside the engraved portion of the resin layer at a certain height or more.

Accordingly, as the pattern portion is disposed while sufficiently filling the inside of the engraved portion, the pattern portion may be disposed in a sufficient size without increasing a thickness of the resin layer, and accordingly, it is possible to maximize the light blocking effect while minimizing the thickness of the optical path control member.

In addition, in the optical path control member according to the embodiment, the pattern portion may be formed by the plurality of light shielding layers.

Accordingly, the pattern portion may be disposed inside the engraved portion while improving the flatness of the upper surface of the pattern portion. Therefore, when the optical path control member is adhered to another member, for example, a member such as a display panel via an adhesive, it is possible to minimize adhesion failure due to a protruding surface of the pattern portion.

Therefore, the optical path control member according to the embodiment may minimize the thickness, and have an improved light blocking effect and reliability.

In addition, the optical path control member according to the embodiment may minimize the height deviation of the pattern portions in the entire region, thereby minimizing the deviation in the light transmittance and the light blocking rate, and accordingly, it is possible to prevent formation of spots or the like due to a difference in brightness by improving the brightness uniformity of the optical path control member.

In addition, the optical path control member according to the embodiment may increase front transmittance to 60% or more and reduce lateral transmittance to 1% or less.

In detail, the optical path control member according to the embodiment may increase the front transmittance and decrease the lateral transmittance by controlling areas of a light shielding portion and a light-emitting portion, a depth of the light shielding portion, and a width of the light-emitting portion.

Accordingly, since a sufficient amount of light is transmitted from the front, it is possible to minimize occurrence of a faint reflection, that is, a virtual image, etc. due to side light by controlling the lateral transmittance to 1% or less while improving a user's visibility, thereby minimizing obstruction of a user's field of view.

Therefore, the optical path control member according to the embodiment may have an improved light transmittance.

In addition, it is possible to secure privacy from other people by blocking observation by other people outside a range of a front viewing angle.

In addition, the optical path control member according to the embodiment may improve transmittance of incident light. That is, by controlling a critical angle at an interface of a transmitting portion through which light is transmitted and an absorbing portion through which light is absorbed, a total reflection region of the light may be increased, thereby increasing an amount of transmitted light.

Accordingly, since light having a sufficient amount of is transmitted, the user's visibility may be improved.

In addition, it is possible to secure privacy from other people by blocking observation by other people outside the range of the front viewing angle.

In addition, the optical path control member according to the embodiment may prevent a moire phenomenon that occurs when a pattern serving as a light absorbing portion overlaps patterns of a light source member coupled to the optical path control member.

That is, a regular pattern due to overlapping of the pattern of the optical path control member and the pattern of the display panel is randomly dispersed by disposing the pattern layer between the pattern of the optical path control member and the pattern of the display panel, or by disposing another additional pattern layer on the optical path control member, and accordingly, the moire phenomenon caused by overlapping of the regular pattern may be minimized.

Therefore, the optical path control member according to the embodiment may improve visibility of the optical path control member and a display device coupled thereto by minimizing the moire phenomenon.

### DESCRIPTION OF DRAWINGS

FIG. 1 is a perspective view of an optical path control member according to embodiments.

FIG. 2 is an upper surface view of the optical path control member according to the embodiments.

FIG. 3 is a cross-sectional view in which a pattern portion is not disposed in a cross-sectional view taken along line A-A′ of FIG. 2.

FIG. 4 is a cross-sectional view taken along line A-A′ of FIG. 2 in an optical path control member according to a first embodiment.

FIG. 5 is an enlarged view of B region of FIG. 4.

FIG. 6 is an enlarged view of C region of FIG. 4.

FIG. 7 is a cross-sectional view taken along line A-A′ of FIG. 2 in an optical path control member according to a second embodiment.

FIG. 8 is a view for describing light transmittance according to a viewing angle of the optical path control member according to the second embodiment.

FIG. 9 is a graph showing light transmittance according to a viewing angle of the optical path control member according to the second embodiment.

FIG. 10 is a cross-sectional view taken along line A-A′ of FIG. 2 in an optical path control member according to a third embodiment.

FIGS. 11 and 12 are views for describing an optical path of an optical path control member according to the third embodiment and a comparative example.

FIG. 13 is a perspective view of an optical path control member according to a fourth embodiment.

FIG. 14 is a perspective view of a pattern layer of the optical path control member according to the fourth embodiment.

FIG. 15 is a cross-sectional view taken along line B-B′ of FIG. 14.

FIG. 16 is another perspective view of a pattern layer of the optical path control member according to the fourth embodiment.

FIG. 17 is a cross-sectional view taken along line C-C′ of FIG. 16.

FIG. 18 is a cross-sectional view in which a resin layer and a pattern layer of the optical path control member according to the fourth embodiment are adhered.

FIG. 19 is another cross-sectional view in which the resin layer and the pattern layer of the optical path control member according to the fourth embodiment are adhered.

FIG. 20 is still another cross-sectional view in which the resin layer and the pattern layer of the optical path control member according to the fourth embodiment are adhered.

FIGS. 21 to 24 are photographs for describing a moire phenomenon of a display panel to which an optical path control member according to the fourth embodiment and a comparative example is applied.

FIG. 25 is a cross-sectional view of a display device to which an optical path control member according to embodiments is applied.

FIG. 26 is a view for describing one embodiment of a display device to which an optical path control member according to embodiments is applied.

### MODES OF THE INVENTION

Hereinafter, embodiments of the present invention will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and replaced.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

In addition, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “connected” to another element, it may include not only when the element is directly “connected” to, “coupled” to, or “connected” to other elements, but also when the element is “connected”, “coupled”, or “connected” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, an optical path control member according to an embodiment will be described with reference to drawings.

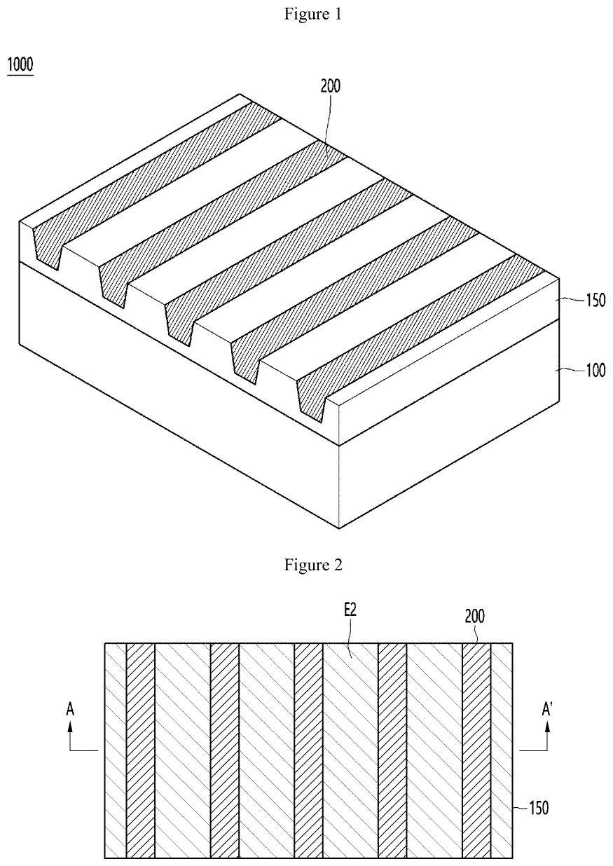

Referring to FIGS. 1 to 3, an optical path control member according to embodiments includes a base substrate 100, a resin layer 150, and a pattern portion 200.

The base substrate 100 may contain a transparent material. The base substrate 100 may contain a flexible material. The base substrate 100 may contain plastic.

For example, the base substrate 100 may contain a plastic material such as poly-ester (PET), poly methyl meta acryl (PMMA), or poly carbonate (PA).

One of a lateral direction and a longitudinal direction of the base substrate 100 may be a longer side direction, the other is a shorter side direction, and the base substrate may have a rectangular parallelepiped shape. Alternatively, sides of the base substrate 100 in the lateral direction and the longitudinal direction have the same size, and the base substrate may have a cubic shape.

The base substrate 100 may include one surface and the other surface. For example, the base substrate 100 may include one surface and the other surface opposite to the one surface with respect to a thickness direction of the base substrate 100.

One surface of the base substrate may be defined as a direction viewed by a user. In addition, the other surface of the base substrate may be defined as a direction in which a light source such as a display panel is disposed. That is, light is emitted from a light source such as a display panel, and the emitted light is incident in the other surface direction of the base substrate, and a display is displayed so that the user may recognize visually the display on the one surface of the base substrate.

The resin layer 150 may be disposed on the base substrate 100. The resin layer 150 may be disposed in direct contact with the base substrate 150. The resin layer 150 may include a photocurable resin such as a UV resin or a thermosetting resin.

Alternatively, the resin layer 150 may include the same material as the base substrate 100. For example, the resin layer 150 may be integrally formed with the base substrate 100.

The resin layer 150 may be disposed on the other surface of the base substrate 100. That is, the resin layer 140 may be disposed on the other surface of the base substrate 100 facing the display panel.

The resin layer 150 may include a lower surface 1S and an upper surface 2S. In detail, the lower surface 1S of the resin layer may be defined as a surface adjacent to the other surface of the base substrate 100. In addition, the upper surface 2S of the resin layer may be defined as a surface opposite to the lower surface 1S of the resin layer.

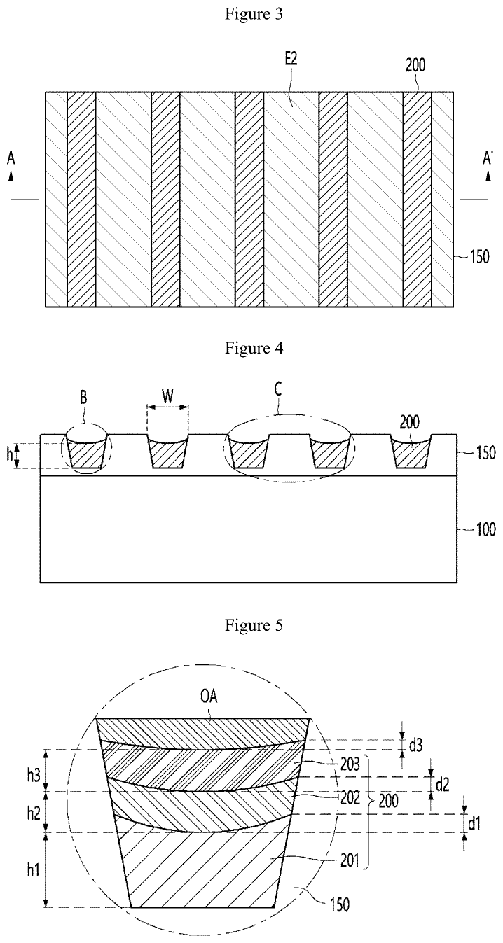

Referring to FIG. 3, an engraved portion may be formed on the upper surface of the resin layer 150. In detail, a plurality of engraved portions E1 formed partially penetrating the upper surface 2S may be formed in the resin layer 150. The engraved portions E1 may be formed by an imprinting process by disposing a mold or the like on the upper surface 2S of the resin layer 150. The engraved portions E1 may be formed by penetrating the upper surface 2S of the resin layer and being etched to a predetermined depth, and accordingly, a plurality of engraved portions having a groove shape in which one end is opened and the other end is closed may be formed in the resin layer.

Accordingly, the engraved portions E1 and embossed portions E2 between the engraved portions E1 may be formed on the resin layer 150.

Hereinafter, an optical path control member according to a first embodiment will be described with reference to FIGS. 1 to 6.

Referring to FIGS. 2 and 4, the pattern portion 200 may be disposed on the base substrate 100. The pattern portion 200 may be disposed on the resin layer 150 on the base substrate 100. In detail, the pattern portion 200 may be disposed inside the engraved portions formed in the resin layer 150.

The pattern portion 200 is disposed inside the plurality of engraved portions, respectively, and accordingly, the pattern portion 200 may include a plurality of pattern portions disposed to be spaced apart from each other.

The pattern portion 200 may include a material having a low light transmittance. The pattern portion 200 may include an opaque material. The pattern portion 200 may include a colored material. For example, the pattern portion 200 may include black carbon ink or black carbon beads. That is, the pattern portion 200 may serve to block light. That is, the pattern portion 200 may be a light blocking pattern.

In addition, the pattern portion 200 and the embossed portion E2 of the resin layer 150 may have different light transmittances. In detail, light transmittance of the embossed portion E2 of the resin layer 150 may be greater than that of the pattern portion 200.

That is, light incident on the optical path control member may be transmitted in the embossed portion E2 of the resin layer 150, and may be blocked in the pattern portion 200.

In detail, a movement path of incident light may be changed by the pattern portion 200. That is, the optical path control member according to the embodiment may partially block and partially transmit the incident light, such that the light is transmitted only at a desired angle and at a desired position.

For example, a path of light in a vertical direction or a horizontal direction based on a user may be controlled by the pattern portion 200. That is, light that deviates more than a specific angle in the vertical direction or the horizontal direction based on a user's viewing angle according to a direction in which the pattern portion extends may not be transmitted.

For example, when the optical path control member according to the embodiment is applied to a vehicle, it is possible to prevent a virtual image or the like that is recognized by light reflected from left and right windows of the vehicle or a windshield of the vehicle while driving. Accordingly, it is possible to prevent a virtual image that obstructs a field of view while driving the vehicle, thereby preventing a risk of an accident associated therewith.

A protective layer disposed on the upper surface 2S of the resin layer may be disposed on the resin layer 150. The protective layer may be disposed while covering the pattern portion 200 of the inside of the engraved portion of the resin layer. Accordingly, the pattern portion may relieve an external impact by the protective layer, and may prevent penetration of impurities such as moisture.

In addition, the protective layer may have an adhesive function. That is, the protective layer may include a release film, and may be adhered to each other by removing the release film when another member and the optical path control member are adhered.

A width w of the pattern portion 200 may be 10 μm or less. In detail, the width w of the pattern portion 200 may be 1 μm to 10 μm. In more detail, the width w of the pattern portion 200 may be 3 μm to 8 μm.

When a size of the width w of the pattern portion 200 exceeds about 10 μm, a size of the optical path control member may be increased by the width w of the pattern portion, and the width of the pattern portion serving to block light is increased, so that the overall brightness of the optical path control member may be lowered as the region through which light is transmitted is reduced.

In addition, when the size of the width w of the pattern portion 200 is less than about 1 μm, an area supporting the pattern portion may be reduced, whereby a light blocking effect due to the patterns may be reduced. The pattern portion may be easily damaged by an external impact, thereby deteriorating reliability.

In addition, the height h of the pattern portion 200 may be about 120 μm or less. In detail, the height h of the pattern portion 200 may be about 20 μm to about 120 μm. In more detail, the height h of the pattern portion 200 may be about 50 μm to about 100 μm.

The height h of the pattern portion 200 may be defined as a distance from an upper region to a lower region of the pattern portion. In detail, the height h of the pattern portion 200 may be defined as a distance from the lowest point of the upper region to the lowest point of the lower region.

In detail, the height h of the pattern portion 200 may be defined as the distance from the lowest point of the upper region of the pattern portion to the lowest point of the lower region of the pattern portion. That is, the pattern portion 200 may be in contact with a lower surface of the engraved portion, and the height of the pattern portion 200 may be defined as a distance from the lowest point of the upper surface of the pattern portion to the lowest point of the engraved portion.

It is difficult to realize in a process that the height h of the pattern portion 200 exceeds about 120 μm, and a thickness of the optical path control member may be increased by the height of the pattern portion 200, and thus it is difficult to reduce the thickness.

In addition, as the height of the pattern portion 200 is increased, the force supporting the pattern is decreased, so that the pattern portion may be easily damaged by an external impact, thereby deteriorating reliability of the optical path control member.

In addition, when the height of the pattern portion 200 is increased, the width of the pattern portion should also be increased to improve the force supporting the pattern portion, but in this case, a region in which the light is blocked becomes too wide, so that the front transmittance of the optical path control member may be reduced, thereby deteriorating the user's visibility.

In addition, when the height h of the pattern portion is less than about 20 μm, the light blocking effect by the pattern portions may be reduced. In addition, since the height of the pattern portion is too low, it may be visible to other users outside a required viewing angle range, which may cause privacy problems.

In addition, a virtual image is displayed on a front glass or a window of a vehicle, which may obstruct the user's field of view, and brightness of light may be reduced and the moire phenomenon may occur at the viewing angle seen by the user due to dispersion of the light.

Each pattern portion of the pattern portions may include a plurality of light shielding layers.

Referring to FIG. 5, each pattern portion may include a first light shielding layer 201, a second light shielding layer 202, and a third light shielding layer 203.

The first light shielding layer 201, the second light shielding layer 202, and the third light shielding layer 203 may be sequentially disposed inside the engraved portion. That is, the first light shielding layer 201 may be disposed inside the engraved portion E1, the second light shielding layer 202 may be disposed on the first light shielding layer 201, and the third light shielding layer 203 may be disposed on the second light shielding layer 202.

The first light shielding layer 201, the second light shielding layer 202, and the third light shielding layer 203 may be formed to have different heights, respectively. In detail, a height h1 of the first light shielding layer 201 may be greater than a height h2 of the second light shielding layer 202 and a height h3 of the third light shielding layer 203. In addition, the height h2 of the second light shielding layer 202 may be greater than the height h3 of the third light shielding layer 203. That is, the light shielding layers of the inside of the engraved portion E1 may be decreased in thickness while moving upward from a lower surface of the engraved portion.

The first light shielding layer 201, the second light shielding layer 202, and the third light shielding layer 203 may be formed of the same material.

Alternatively, the first light shielding layer 201, the second light shielding layer 202, and the third light shielding layer 203 may be formed of different materials.

For example, the first light shielding layer 201, the second light shielding layer 202, and the third light shielding layer 203 may contain materials having different viscosities. In detail, the first light shielding layer 201 may contain a material having a lower viscosity than those of the second light shielding layer 202 and the third light shielding layer 203. In addition, the second light shielding layer 202 may contain a material having a lower viscosity than that of the third light shielding layer 203.

That is, the viscosity of the light shielding layer may increase as moving upward from the lower surface of the engraved portion inside the engraved portion E1. Accordingly, when the second light shielding layer 202 and the third light shielding layer 203 are formed on the first light shielding layer 201, it is possible to prevent the second light shielding layer 202 and the third light shielding layer 203 from being not supported or deformed in shape due to viscosity characteristics by forming the first light shielding layer 201 of a material having a low viscosity. Accordingly, the plurality of light shielding layers may be stably formed inside the engraved portion.

In addition, the first light shielding layer 201, the second light shielding layer 202, and the third light shielding layer 203 may contain materials having different light transmittances.

For example, the first light shielding layer 201 may contain a material having a lower light transmittance than those of the second light shielding layer 202 and the third light shielding layer 203. That is, the first light shielding layer 201 disposed at the largest height inside the engraved portion may contain a material having a lower light transmittance than those of the second light shielding layer 202 and the third light shielding layer 203, that is, a material having a good light blocking effect.

In addition, the second light shielding layer 202 and the third light shielding layer 203 may contain a material having a higher light transmittance than that of the first light shielding layer 201, that is, a material having a relatively small light blocking effect. In addition, the second light shielding layer 202 and the third light shielding layer 203 may contain a material having a relatively small light blocking effect, but having small printing characteristics, that is, a small surface roughness, and accordingly, it is possible to improve surface planarization by reducing the surface roughness of the final light shielding layer exposed to the outside from the inside of the engraved portion.

The height h of the pattern portion, that is, the total height h1+h2+h3 of the first light shielding layer 201, the second light shielding layer 202, and the third light shielding layer 203 may be equal to or less than the total height of the engraved portion E1. That is, the height h of the pattern portion defined as the distance from the lowest point of the upper region to the lowest point of the lower region may be less than or equal to the height of the engraved portion E1.

In detail, the height h of the pattern portion may be 93% or more of the height of the engraved portion and equal to or less than the height of the pattern portion.

Preferably, the height h of the pattern portion may be disposed at a height of 93% or more of the maximum depth of the engraved portion to a height equal to or less than the maximum depth of the engraved portion. In detail, the height h of the pattern portion may be disposed at least 95% of the maximum depth of the engraved portion to equal to or less than the maximum depth of the engraved portion. In detail, the height h of the pattern portion may be disposed at a height of 97% or more of the maximum depth of the engraved portion to equal to or less than the maximum depth of the engraved portion.

When the pattern portion is formed to be less than 91% of the maximum depth of the engraved portion formed in the resin layer, the resin layer may be thicker compared to the height of the pattern portion for forming the same shielding function, so that the overall thickness of the optical path control member may be increased. In addition, when exceeding the maximum depth of the engraved portion, while forming the pattern portion, an ink material is formed outside the engraved portion or the pattern portion is formed protruding from the engraved portion, and accordingly, poor bonding between the optical path control member and the display, a protective film, or the like may occur.

In addition, distances between the highest point and the lowest point of upper surfaces of the first light shielding layer 201, the second light shielding layer 202, and the third light shielding layer 203 may be different from each other.

In detail, a first distance d1 between the highest point and the lowest point of an upper surface of the first light shielding layer 201 may be defined, a second distance d2 between the highest point and the lowest point of an upper surface of the second light shielding layer 202 may be defined, and a third distance h between the highest point and the lowest point of an upper surface of the third light shielding layer 203 may be defined.

In this case, magnitudes of the first distance d1, the second distance d2, and the third distance h may be different from each other. In detail, the first distance d1 may be greater than the second distance d2 and the third distance h, and the second distance d2 may be greater than the third distance h. That is, the distance between the highest point and the lowest point of the upper surface of the light shielding layer may be reduced while moving upward from the lower surface of the engraved portion.

Accordingly, the flatness of the upper surface of the pattern portion 200 including the plurality of light shielding layers may be improved. Accordingly, when an adhesive layer and a display panel are disposed on the upper surface 2S of the resin layer 150, adhesion failure due to the pattern portion may be minimized to improve adhesive characteristics.

Meanwhile, an entire internal area of the engraved portion and a filling area of the pattern portion may be different from each other. In detail, the entire internal area of the engraved portion may be larger than the filling area of the pattern portion. That is, the upper surface of the pattern portion 200 disposed inside the engraved portion E1 includes a concave surface, and accordingly, a region OA in which the pattern portion 200 is not filled may be formed inside the engraved portion E1.

That is, the upper surface of the light shielding layer disposed on the uppermost portion of the pattern portion 200 may include the highest point and the lowest point, and the region OA in which the pattern portion 200 is not filled may be formed inside the engraved portion E1 by the distance between the highest point and the lowest point.

The optical path control member according to the first embodiment may form the pattern portion disposed inside the engraved portion of the resin layer at a certain height or more.

Accordingly, as the pattern portion is disposed while sufficiently filling the inside of the engraved portion, the pattern portion may be disposed in a sufficient size without increasing a thickness of the resin layer, and accordingly, it is possible to maximize the light blocking effect while minimizing the thickness of the optical path control member.

In addition, in the optical path control member according to the first embodiment, the pattern portion may be formed by the plurality of light shielding layers.

Accordingly, the pattern portion may be disposed inside the engraved portion while improving the flatness of the upper surface of the pattern portion. Therefore, when the optical path control member is adhered to another member, for example, a member such as a display panel via an adhesive, it is possible to minimize adhesion failure due to a protruding surface of the pattern portion.

Therefore, the optical path control member according to the first embodiment may minimize the thickness, and have an improved light blocking effect and reliability.

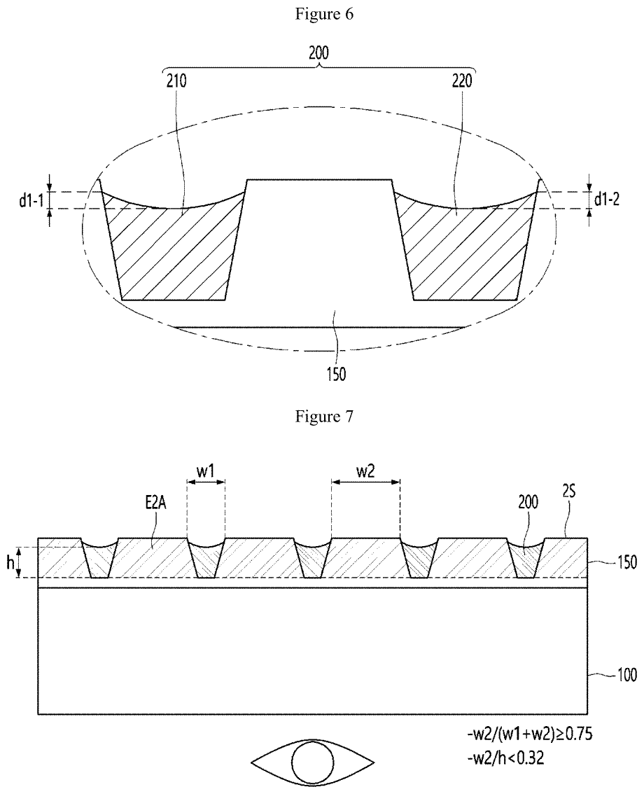

Referring to FIG. 6, the pattern portion may include a plurality of pattern portions adjacent to each other.

For example, the pattern portion 200 may include a first pattern portion 210 and a second pattern portion 220 disposed to be spaced apart from each other.

The first pattern portion 210 and the second pattern portion 220 may be disposed inside each engraved portion.

An upper surface of the first pattern portion 210 may have a height deviation. In detail, the upper surface of the first pattern portion 210 may have a height deviation of about a first-first distance d1-1 defined as the distance between the highest point and the lowest point.

In addition, an upper surface of the second pattern portion 220 may have a height deviation. In detail, the upper surface of the second pattern portion 220 may have a height deviation of about a first-second distance d1-2 defined as the distance between the highest point and the lowest point.

In this case, the first-first distance d1-1 and the first-second distance d1-2 may have the same magnitudes or may have a difference of about a certain magnitude.

For example, a difference in magnitude between the first-first distance d1-1 and the first-second distance d1-2 may be 1 μm or less. That is, the first-first distance d1-1 and the first-second distance d1-2 may have the same magnitude or a difference of about 1 μm or less.

Accordingly, the optical path control member according to the first embodiment may minimize the height deviation of the pattern portions. That is, the height deviation of the pattern portions is controlled to be about 1 μm or less, whereby it is possible to minimize a deviation in light transmittance and light blocking rate in the entire region of the optical path control member.

Therefore, the optical path control member according to the first embodiment may minimize the height deviation of the pattern portions in the entire region, thereby minimizing the deviation in the light transmittance and the light blocking rate, and accordingly, it is possible to prevent formation of spots or the like due to a difference in brightness by improving the brightness uniformity of the optical path control member.

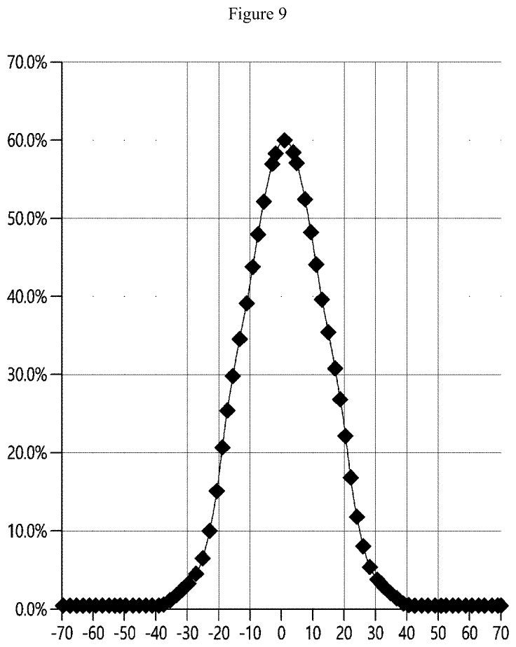

Hereinafter, an optical path control member according to a second embodiment will be described with reference to FIGS. 1 to 3 and FIGS. 7 to 9. In description of the optical path control member according to the second embodiment, the description that is the same as or similar to that of the optical path control member according to the first embodiment described above will be omitted. In addition, in the description of the optical path control member according to the second embodiment, the same components as the optical path control member according to the first embodiment described above are designated by the same reference numerals.

Referring to FIGS. 2 and 7, the pattern portion 200 may be disposed on the base substrate 100. The pattern portion 200 may be disposed on the resin layer 150 on the base substrate 100. In detail, the pattern portion 200 may be disposed inside the engraved portions formed in the resin layer 150.

The pattern portion 200 is disposed inside the plurality of engraved portions, respectively, and accordingly, the pattern portion 200 may include a plurality of pattern portions disposed to be spaced apart from each other.

The pattern portion 200 may include a material having a low light transmittance. The pattern portion 200 may include an opaque material. The pattern portion 200 may include a colored material. For example, the pattern portion 200 may include black ink.

For example, the black ink may contain at least one of black carbon ink and black carbon beads. As an example, the black ink may be formed by adding carbon beads to the carbon ink.

At this time, the black carbon beads may have a diameter of about 10 nm to about 100 nm, and may be contained in an amount of about 3% by weight based on the total ink weight.

In addition, the absorbance of the black ink may be 4 or more.

Accordingly, a lateral transmittance of the optical path control member may be reduced to 1% or less. Thus, the pattern portion 200 may serve to block light. That is, the pattern portion 200 may be a light blocking pattern.

In addition, the embossed portion E2 of the pattern portion 200 and the resin layer 150, that is, a non-pattern portion may have different light transmittances. In detail, light transmittance of light passing through the embossed portion E2 of the resin layer 150 may be greater than that of light passing through the pattern portion 200.

That is, light incident on the optical path control member may be transmitted in the embossed portion E2 of the resin layer 150, and may be blocked in the pattern portion 200.

In detail, a movement path of incident light may be changed by the pattern portion 200. That is, the optical path control member according to the embodiment may partially block and partially transmit the incident light, such that the light is transmitted only at a desired angle and at a desired position.

For example, a path of light in a vertical direction or a horizontal direction based on a user may be controlled by the pattern portion 200. That is, light that deviates more than a specific angle in the vertical direction or the horizontal direction based on a user's viewing angle according to a direction in which the pattern portion extends may not be transmitted.

For example, when the optical path control member according to the embodiment is applied to a vehicle, it is possible to prevent a virtual image or the like that is recognized by light reflected from left and right windows of the vehicle or a windshield of the vehicle while driving. Accordingly, it is possible to prevent a virtual image that obstructs a field of view while driving the vehicle, thereby preventing a risk of an accident associated therewith.

In addition, when there are other people around the user, it is possible to secure privacy from other people by blocking observation by other people outside the range of the front viewing angle.

A protective layer disposed on the upper surface 2S of the resin layer may be disposed on the resin layer 150. The protective layer may be disposed while covering the pattern portion 200 of the inside of the engraved portion of the resin layer. Accordingly, the pattern portion may relieve an external impact by the protective layer, and may prevent penetration of impurities such as moisture.

In addition, the protective layer may have an adhesive function. That is, the protective layer may include a release film, and may be adhered to each other by removing the release film when another member and the optical path control member are adhered. That is, it is possible to facilitate adhesion of the optical path control member to other members by forming an adhesive force of the protective layer larger than that of the resin layer.

A width w of the pattern portion 200 may be 10 μm or less. In detail, the width w of the pattern portion 200 may be 1 μm to 10 μm. In more detail, the width w of the pattern portion 200 may be 3 μm to 8 μm.

When a size of the width w of the pattern portion 200 exceeds about 10 μm, a size of the optical path control member may be increased by the width w of the pattern portion, and the width of the pattern portion serving to block light is increased, so that the overall brightness of the optical path control member may be lowered as the region through which light is transmitted is reduced.

In addition, when the size of the width w of the pattern portion 200 is less than about 1 μm, an area supporting the pattern portion may be reduced, whereby a light blocking effect due to the patterns may be reduced. The pattern portion may be easily damaged by an external impact, thereby deteriorating reliability.

In addition, the height h of the pattern portion 200 may be about 120 μm or less. In detail, the height h of the pattern portion 200 may be about 20 μm to about 120 μm. In more detail, the height h of the pattern portion 200 may be about 50 μm to about 100 μm.

The height h of the pattern portion 200 may be defined as a distance from an upper region to a lower region of the pattern portion. In detail, the height h of the pattern portion 200 may be defined as a distance from the lowest point of the upper region to the lowest point of the lower region.

In detail, the height h of the pattern portion 200 may be defined as a distance from the lowest point of the upper region of the pattern portion to the lowest point of the lower region of the pattern portion. That is, the pattern portion 200 may be in contact with a lower surface of the engraved portion, and the height of the pattern portion 200 may be defined as a distance from the lowest point of the upper surface of the pattern portion to the lowest point of the engraved portion.

It is difficult to realize in a process that the height h of the pattern portion 200 exceeds about 120 μm, and a thickness of the optical path control member may be increased by the height of the pattern portion 200, and thus it is difficult to reduce the thickness.

In addition, as the height of the pattern portion 200 is increased, the force supporting the pattern is decreased, so that the pattern portion may be easily damaged by an external impact, thereby deteriorating reliability of the optical path control member.

In addition, when the height of the pattern portion 200 is increased, the width of the pattern portion should also be increased to improve the force supporting the pattern portion, but in this case, a region in which the light is blocked becomes too wide, so that the front transmittance of the optical path control member may be reduced, thereby deteriorating the user's visibility.

In addition, the height h of the pattern portion 200 may be equal to or less than an inner depth of the engraved portion formed in the resin layer 150. Thus, when the optical path control member including the pattern portion 200 and the display are coupled to each other, it is possible to prevent an adhesion failure due to a pattern exposed to the outside, thereby improving reliability. In detail, an upper surface of the pattern portion 200 may include a concave shape, and a region in which the pattern portion is not filled may be formed inside the engraved portion of the resin layer 150 by the concave shape.

Preferably, the pattern portion 200 may be disposed at a height of 90% or more and less than 100% of the maximum depth of the engraved portion formed in the resin layer 150. In detail, the pattern portion 200 may be disposed at a height of 91% or more and less than 98% of the maximum depth of the engraved portion formed in the resin layer 150. In detail, the pattern portion 200 may be disposed at a height of 93% or more and less than 96% of the maximum depth of the engraved portion formed in the resin layer 150.

In addition, when the height h of the pattern portion is less than about 20 μm, the light blocking effect by the pattern portions may be reduced. In addition, since the height of the pattern portion is too low, it may be visible to other users outside a required viewing angle range, which may cause privacy problems.

In addition, a virtual image is displayed on a front glass or a window of a vehicle, which may obstruct the user's field of view, and brightness of light may be reduced and the moire phenomenon may occur at the viewing angle seen by the user due to dispersion of the light.

Referring to FIG. 7, a first distance w1 defined as a width of the pattern portion, a second distance w2 defined as a width of the embossed portion, that is, a non-pattern portion, and a third distance h defined as a height of the pattern portion may be defined.

In detail, the first distance w1 may be defined as a width of each pattern portion, the second distance w2 may be defined as a distance between the pattern portions, and the third distance h may be defined as a height of each pattern portion. When the second distance w2 is redefined, it may be defined as the width of the embossed portion E2, that is, a light transmitting portion through which light is transmitted.

In this case, the first distance w1, the second distance w2, and the third distance h may satisfy the following Equation 1.

Second distance/(First distance+Second distance)≥0.75 [Equation 1]

In detail, the above Equation 1 is a value that defines an area ratio of the light transmitting portion through which light is transmitted and the pattern portion through which light is not transmitted. That is, the embossed portion E2 may be formed in an area of about 75% or more of the total area of the pattern portion 200 and the embossed portion E2 which is the light transmitting portion.

Here, an area E2A of the embossed portion E2 may be defined as the total area of a plurality of embossed portions, as shown in FIGS. 2 to 4. In this case, an area of each embossed portion may be defined as an area from a lower surface of each embossed portion parallel to an extension line of the lowest point of the engraved portion to an upper surface of each embossed portion.

Accordingly, when light emitted from an upper surface of the resin layer 150 and passing through a lower surface of the resin layer 150 is defined as 100%, and it is assumed that the resin layer 150 transmits all 100% of the light, light moving from the upper surface 2S of the resin layer toward the lower surface 1S of the resin layer may be transmitted by 75% or more through the embossed portion E2.

Accordingly, the optical path control member according to the embodiment may control front transmittance to be 60% or more. That is, when the light emitted from the upper surface of the resin layer 150 and passing through the lower surface of the resin layer 150 is defined as 100%, transmittance of light emitted in a front direction may be controlled to be 60% or more by controlling the area of the embossed portion E2, which is the light transmitting portion, in consideration of the light absorbed from the resin layer 150, the embossed portion E2, and the pattern portion.

Meanwhile, the second distance d2 and the third distance h may satisfy the following Equation 2.

Second distance/Third distance<0.32 [Equation 2]

That is, the third distance h may be greater than the second distance w2. In other words, a depth of the pattern portion may be large, and the width of the light transmitting portion may be small.

The optical path control member according to the embodiment may reduce the light transmittance in a region having a viewing angle of 60° or more when the viewing angle at a front of the optical path control member is defined as 0° by Equation 2 above.

In detail, it is possible to reduce the light transmittance in the region having the viewing angle of 60° or more by increasing a length of the pattern portion, and also, it is possible to increase the front light transmittance defined as the viewing angle of 0° by reducing the width of the light transmitting portion to minimize dispersion of light by reflection.

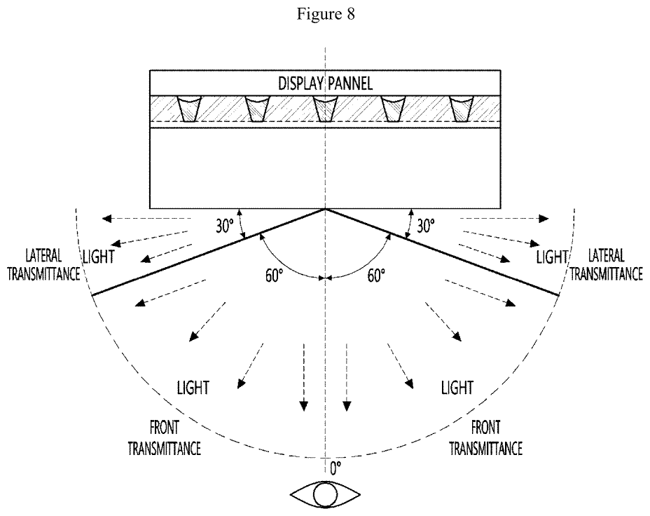

FIG. 8 is a view showing light transmittance according to a viewing angle of the optical path control member according to the second embodiment.

Referring to FIG. 8, when an extension line of a field of view in which a user looks at a display is defined as 0°, a region of a viewing angle from 0° to 60° is defined as front transmittance, and a region exceeding 60° is defined as lateral transmittance, the front transmittance may be about 60% or more, and the lateral transmittance may be about 1% or less.

Accordingly, a user's visibility is improved by increasing the front transmittance, while the lateral transmittance is reduced, thereby preventing a phenomenon in which the field of view of the user is obstructed due to a faint reflection on a glass or the like by light transmitted to the side.

In addition, it is possible to secure privacy from other people while allowing light to be visually recognized only at a certain viewing angle.

Hereinafter, the present invention will be described in more detail through front transmittance and lateral transmittance of the optical path control member according to the embodiments and Comparative Examples. These Examples are merely illustrative to describe the present invention in more detail. Therefore, the present invention is not limited thereto.

### Embodiment 2

After a UV resin was disposed on a polyethylene terephthalate substrate, a plurality of engraved portions and a plurality of embossed portions disposed between the plurality of engraved portions were formed on the UV resin by an imprinting process.

Subsequently, black ink was filled by screen printing inside the plurality of engraved portions to form a pattern portion inside the engraved portions.

Subsequently, black ink adhering to regions other than the engraved portions was removed to manufacture a final optical path control member.

At this time, the black ink contained black carbon ink and black carbon beads, and a diameter of the black carbon beads was 33 nm, which contained 5% or more of the entire ink.

Subsequently, after setting a width of the pattern portion and a width of the embossed portion as shown in Table 1 below, the front transmittance (viewing angle from 0° to 60°) and the lateral transmittance (viewing angle exceeding 60° to 90°) were measured.

### Comparative Examples 1 to 3

After forming the optical path control member in the same manner as in Embodiment 2, the height and width of the pattern portion and the width of the embossed portion were set differently from those of Example 2 as shown in Table 1 below, and then the front transmittance (viewing angle from 0° to 60°) and the lateral transmittance (viewing angle exceeding 60° to) 90° were measured.

TABLE 1

| | Embodiment | Comparative | Comparative | Comparative |
|---|---|---|---|---|
| | 2 | Example | Example | Example |
| | (%) | 1 (%) | 2 (%) | 3 (%) |
| Width of | 9 | 18 | 21 | 12 |
| pattern portion | | | | |
| (d1) | | | | |
| Width of | 27 | 28 | 33 | 38 |
| embossed | | | | |
| portion (d2) | | | | |
| Depth of | 100 | 100 | 100 | 100 |
| pattern portion | | | | |
| (h) | | | | |
| d2/(d1 + d2) | 75 | 60.9 | 61.1 | 76 |
| d2/h | 0.27 | 0.28 | 0.33 | 0.38 |

TABLE 2

| | Embodiment | Comparative | Comparative | Comparative |
|---|---|---|---|---|
| | 2 | Example | Example | Example |
| | (%) | 1 (%) | 2 (%) | 3 (%) |
| Front | 61 | 50 | 51 | 62.1 |
| transmittance | | | | |
| Lateral | 0.1 | 0.2 | 1.1 | 2 |
| transmittance | | | | |

TABLE 3

| Viewing angle (°) | Transmittance (%) |
|---|---|
| −70 | 0.2 |
| −60 | 0.2 |
| −50 | 0.3 |
| −40 | 0.5 |
| −30 | 3.1 |
| −20 | 20.6 |
| −10 | 43.7 |
| 0 | 61.1 |
| 10 | 43.9 |
| 20 | 21.9 |
| 30 | 3.8 |
| 40 | 0.7 |
| 50 | 0.3 |
| 60 | 0.2 |
| 70 | 0.2 |

Referring to Tables 1 and 2, it can be seen that the front light transmittance of the optical path control member according to Embodiment 2 is 60% or more, and the lateral light transmittance is 1% or less.

On the other hand, the optical path control members according to Comparative Examples 1 and 2 do not satisfy Equation 1, and accordingly, it can be seen that the front light transmittance is less than 60%.

In addition, the optical path control member according to Comparative Example 3 satisfies Equation 1 and satisfies the front light transmittance of 60% or more, but does not satisfy Equation 2, and accordingly, it can be seen that the lateral light transmittance is very high compared to Example 2.

That is, referring to Table 3 and FIG. 6, in the optical path control member according to Embodiment 2, it can be seen that light transmittance at 0° to 60° defined as the front transmittance is at maximum 61.1%, and light transmittance exceeding 60° defined as the lateral transmittance is 0.2% or less.

That is, the optical path control member according to the second embodiment may control the front transmittance above a certain range to improve the user's visibility, and simultaneously may control the lateral transmittance below a certain range to prevent a virtual image or the like due to side light.

Hereinafter, an optical path control member according to a third embodiment will be described with reference to FIGS. 1 to 3 and FIGS. 10 to 12. In description of the optical path control member according to the third embodiment, the description that is the same as or similar to that of the optical path control member according to the first and second embodiments described above will be omitted. In addition, in the description of the optical path control member according to the third embodiment, the same components as the optical path control member according to the first and second embodiments described above are designated by the same reference numerals.

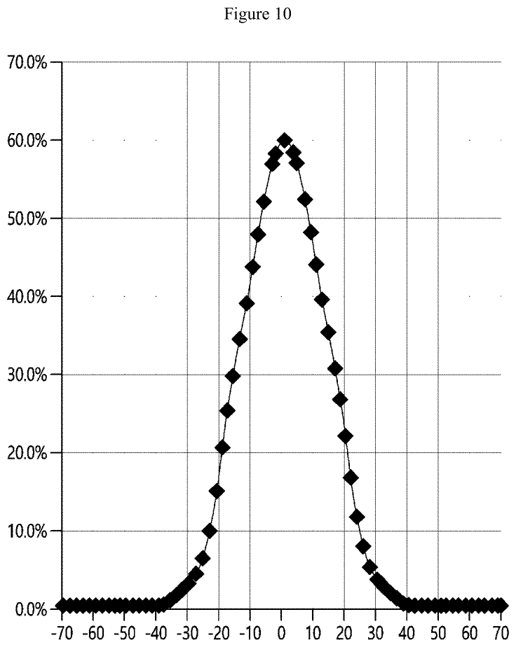

Referring to FIGS. 2 and 10, the pattern portion 200 may be disposed on the base substrate 100. The pattern portion 200 may be disposed on the resin layer 150 on the base substrate 100. In detail, the pattern portion 200 may be disposed inside the engraved portions formed in the resin layer 150.

The pattern portion 200 is disposed inside the plurality of engraved portions, respectively, and accordingly, the pattern portion 200 may include a plurality of pattern portions disposed to be spaced apart from each other.

The pattern portion 200 may include a material having a low light transmittance. The pattern portion 200 may include an opaque material. The pattern portion 200 may include a colored material. For example, the pattern portion 200 may include black ink.

For example, the black ink may contain at least one of black carbon ink and black carbon beads. As an example, the black ink may be formed by adding carbon beads to the carbon ink.

That is, the pattern portion 200 may be a light blocking pattern.

In addition, the embossed portion E2 of the pattern portion 200 and the resin layer 150, that is, a non-pattern portion may have different light transmittances. In detail, light transmittance of light passing through the embossed portion E2 of the resin layer 150 may be greater than that of light passing through the pattern portion 200.

That is, light incident on the optical path control member may be transmitted in the embossed portion E2 of the resin layer 150, and may be blocked in the pattern portion 200. That is, the embossed portion E2 may be a light transmitting portion, and the pattern portion 200 may be a light absorbing portion.

In detail, a movement path of incident light may be changed by the pattern portion 200. That is, the optical path control member according to the embodiment may partially block and partially transmit the incident light, such that the light is transmitted only at a desired angle and at a desired position.

For example, a path of light in a vertical direction or a horizontal direction based on a user may be controlled by the pattern portion 200. That is, light that deviates more than a specific angle in the vertical direction or the horizontal direction based on a user's viewing angle according to a direction in which the pattern portion extends may not be transmitted.

For example, when the optical path control member according to the embodiment is applied to a vehicle, it is possible to prevent a virtual image or the like that is recognized by light reflected from left and right windows of the vehicle or a windshield of the vehicle while driving. Accordingly, it is possible to prevent a virtual image that obstructs a field of view while driving the vehicle, thereby preventing a risk of an accident associated therewith.

In addition, when there are other people around the user, it is possible to secure privacy from other people by blocking observation by other people outside the range of the front viewing angle.

The pattern portion 200 and the embossed portion E2 may have different refractive indices. In detail, the refractive index of the embossed portion E2 may be greater than that of the pattern portion 200. That is, the refractive index of the embossed portion E2, which is a region through which light is transmitted inside the resin layer 150, is greater than the refractive index of the pattern portion 200, which is a region through which light is not transmitted inside the resin layer 150.

When a magnitude of the refractive index of the embossed portion E2 is less than a magnitude of the refractive index of the pattern portion 200, light moving toward a lower surface from an upper surface of the resin layer does not move in a direction of the embossed portion E2 at an interface between the embossed portion E2 and the pattern portion 200, and may move in a direction of the pattern portion 200. That is, the light is not reflected at the interface between the embossed portion E2 and the pattern portion 200, but may be absorbed into the pattern portion.

Accordingly, as an amount of the emitted light absorbed by the pattern portion increases, an amount of light moving in the lower surface direction of the resin layer decreases, and accordingly, the overall brightness of the optical path control member may be lowered.

The pattern portion 200 and the embossed portion E2 may be in contact with each other. That is, the pattern portion 200 and the embossed portion E2 may be in contact with each other to form an interface S.

The light moving toward the lower surface from the upper surface of the resin layer 150 may be reflected or refracted at the interface S.

At this time, a critical angle of the light moving toward the lower surface from the upper surface of the resin layer 150 may be about 63° to about 79°. That is, light moving toward the lower surface from the upper surface of the resin layer 150 may be reflected from the interface S toward the embossed portion E2 at the critical angle of about 63° to about 79°.

Accordingly, the optical path control member according to the embodiment may increase the amount of the light moving toward the lower surface of the resin layer. That is, the optical path control member according to the embodiment may increase a total reflection region moving toward the lower surface of the resin layer by controlling the critical angle of the light moving toward the lower surface from the upper surface of the resin layer 150 to be about 63° to about 79°.

Accordingly, in the optical path control member according to the embodiment, the total reflection region of the light moving toward the lower surface of the resin layer may be increased, so that the light transmittance may be increased, and the overall brightness of the optical path control member may be improved.

A critical angle θ at the interface S may be changed by the refractive index of the embossed portion E2 and the refractive index of the pattern portion 200. That is, the critical angle θ at the interface S may be defined by the following equation.

Refractive index of pattern portion/Refractive index of embossed portion=Sin(θ) [Equation]

The refractive index of the embossed portion E2 may be 1.54 to 1.64. In addition, the refractive index of the pattern portion 200 may be 1.47 to 1.51.

In addition, a difference between the refractive index of the embossed portion and the refractive index of the pattern portion may be 0.16 or less. In detail, the difference between the refractive index of the embossed portion and the refractive index of the pattern portion may be 0.1 to 0.16.

When the difference between the refractive index of the embossed portion and the refractive index of the pattern portion is less than 0.1, the critical angle at the interface is increased, and accordingly, the total reflection region of the light is reduced, so that the light transmittance may be decreased.

In addition, when the difference between the refractive index of the embossed portion and the refractive index of the pattern portion exceeds 0.16, the critical angle at the interface is increased, and accordingly, the total reflection region of the light is excessively increased, so that light having an undesired viewing angle may be emitted.

The optical path control member according to the embodiment may improve transmittance of incident light. That is, by controlling the critical angle at the interface of the transmitting portion through which light is transmitted and the absorbing portion through which light is absorbed, the total reflection region of the light may be increased, thereby increasing the amount of transmitted light.

Accordingly, since light having a sufficient amount of is transmitted, the user's visibility may be improved.

In addition, it is possible to secure privacy from other people by blocking observation by other people outside the range of the front viewing angle.

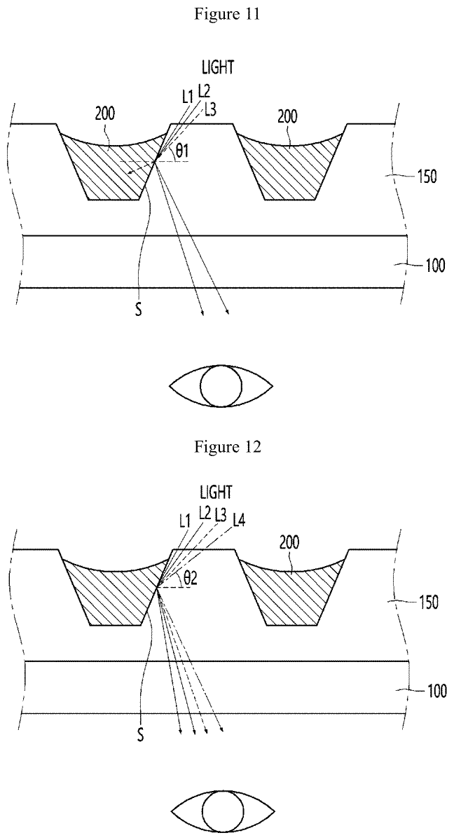

FIG. 11 is a view illustrating an optical path of a conventional optical path control member, and FIG. 12 is a view illustrating an optical path of an optical path control member according to the third embodiment.

Referring to FIGS. 11 and 12, a plurality of lights having different incidence angles may be incident on each optical path control member in a direction of an upper surface of the resin layer 150.

Referring to FIG. 11, a first light L1, a second light L2, and a third light L3, of which incidence angles gradually decrease, may be incident on the conventional optical path control member.

At this time, it can be seen that both of the first light L1 and the second light L2 are totally reflected and emitted onto the base substrate 100, but the third light L3 is refracted in the direction of the pattern portion 200 and light loss occurs.

Meanwhile, referring to FIG. 12, a first light L1, a second light L2, a third light L3, and a fourth light L4 of which incident angles gradually decrease, may be incident on the optical path control member according to the embodiment.

At this time, it can be seen that the first light L1, the second light L2, the third light L3, and the fourth light L4 are all totally reflected and emitted onto the base substrate 100.

That is, it can be seen that a critical angle θ2 of the optical path control member according to the embodiment is smaller than a critical angle θ1 of the conventional optical path control member.

Accordingly, it can be seen that the total reflection region is increased and an amount of light emitted to the base substrate 100 is increased.

Hereinafter, the present invention will be described in more detail through front transmittance and lateral transmittance of an optical path control member according to Embodiments and Comparative Examples. These Examples are merely illustrative to describe the present invention in more detail. Therefore, the present invention is not limited thereto.

### Embodiment 3

After a UV resin was disposed on a polyethylene terephthalate substrate, a plurality of engraved portions and a plurality of embossed portions disposed between the plurality of engraved portions were formed on the UV resin by an imprinting process.

Subsequently, black ink was filled by screen printing inside the plurality of engraved portions to form a pattern portion inside the engraved portions.

Subsequently, black ink adhering to regions other than the engraved portions was removed to manufacture a final optical path control member.

Subsequently, light transmittance incident from an upper surface of the UV resin and emitted toward the polyethylene terephthalate substrate was measured.

### Comparative Example

Except that the refractive index of the embossed portion was set differently, after forming the optical path control member in the same manner as in Example, the light transmittance incident from the upper surface of the UV resin and emitted toward the polyethylene terephthalate substrate was measured.

TABLE 4

| | Embodiment | Comparative |
|---|---|---|
| | 3 | Example |
| Refractive index of embossed portion | 1.62 | 1.51 |
| Refractive index of pattern portion | 1.47 | 1.47 |
| Light transmittance | 65% | 50% |

Referring to Table 4, it can be seen that light transmittance of the optical path control member according to Embodiment 3 is increased as compare with the optical path control member according to Comparative Example.

That is, it can be seen that the optical path control member according to Embodiment 3 controls a critical angle of light incident on the resin layer by a difference in refractive index between the transmitting portion and the absorbing portion to increase the total reflection region of light, thereby increasing the overall light transmittance.

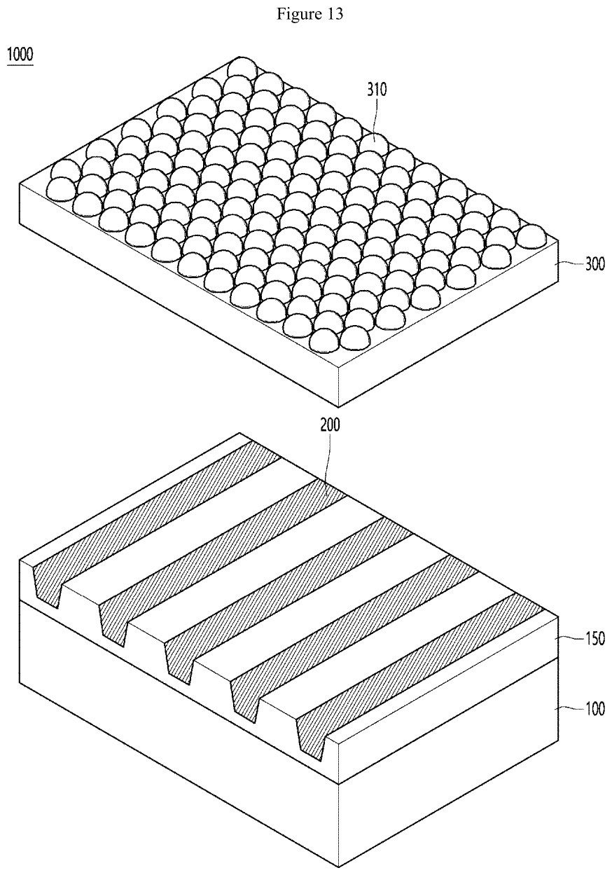

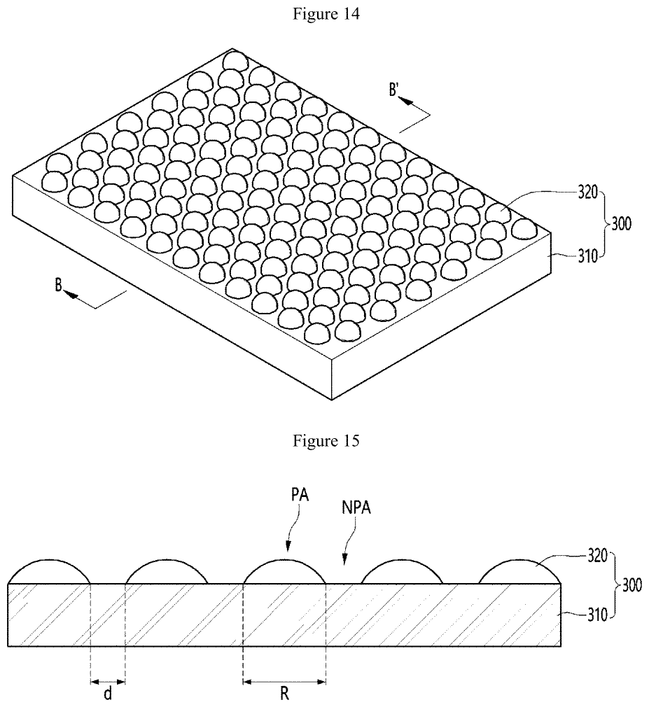

Hereinafter, an optical path control member according to a fourth embodiment will be described with reference to FIGS. 13 to 24. In description of the optical path control member according to the fourth embodiment, the description that is the same as or similar to that of the optical path control member according to the first, second, and third embodiments described above will be omitted. In addition, in the description of the optical path control member according to the fourth embodiment, the same components as the optical path control member according to the first, second, and third embodiments described above are designated by the same reference numerals

Referring to FIGS. 13 and 16, a pattern layer 300 may be disposed on the base substrate 100. In detail, the pattern layer 300 may be disposed in the upper portion 2S of the resin layer 150.

The resin layer 150 and the pattern layer 300 may be adhered to each other. In detail, an adhesive layer may be disposed between the resin layer 150 and the pattern layer 300, and the resin layer 150 and the pattern layer 300 may be adhered to each other via the adhesive layer.

The pattern layer 300 may include a substrate 310 and a plurality of patterns 320 disposed on the substrate 310.

The substrate 310 may contain a material that is the same as or similar to that of the base substrate 100. For example, the substrate 310 may contain plastic. As an example, the substrate 310 may contain at least one material of polyethylene terephthalate (PET), polycarbonate (PC), urethane acrylate resin, urethane melamine resin, polymethyl methacrylate, polyurethane resin, nylon resin, silicone resin, PI, TAC, and Pol film.

The plurality of patterns 320 may be disposed on the substrate 310. In detail, the plurality of patterns 320 disposed to be spaced apart from each other may be disposed on the substrate 310.

The patterns 320 may be formed in a hemispherical shape. For example, the patterns 320 may be a micro lens array (MLA).

Referring to 14 and 15, sizes of the patterns 320 may be disposed to be the same size as each other. In detail, the patterns 320 on the substrate 310 may be formed in the same shape and size as each other.

In detail, a diameter R of the patterns 320 may be about 15 μm or less. In detail, the diameter R of the patterns 320 may be 8 μm to 15 μm.

When the diameter of the patterns 320 exceeds 15 μm, an area of the pattern layer is increased by a number of the patterns 320, so that the overall size of the optical path control member may be increased. In addition, when the diameter of the patterns 320 is less than 8 μm, moire is not completely removed when the optical path control member is coupled to a display panel or the like, and visibility may be deteriorated.

That is, the patterns 320 on the substrate 310 may be disposed with the same diameter as each other within a range of the numerical values. That is, the patterns 320 may be disposed in a regular arrangement having the same diameter within the range of the numerical values.

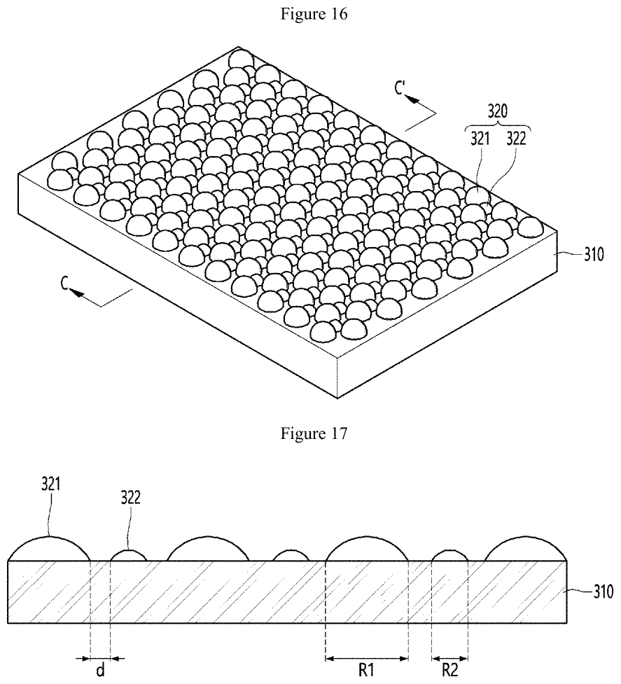

In addition, referring to FIGS. 16 and 17, sizes of the patterns 320 may be disposed in different sizes from each other. In detail, the patterns 320 on the substrate 310 may be formed in different shapes or sizes from each other.

In detail, the patterns 320 may include two or more patterns having different sizes from each other. That is, the diameter of the patterns 320 may be disposed having different diameters within the range of the numerical values to be disposed in a random shape.

For example, the patterns 320 may include a first pattern 321 and a second pattern 322 formed with different diameters from each other. In this case, a diameter R1 of the first pattern 321 may be larger than a diameter R2 of the second pattern 322.

That is, the patterns 320 on the substrate 310 may be disposed in different diameters from each other within the range of the numerical values. That is, the patterns 320 may be disposed in an irregular arrangement having the same diameter within the range of the numerical values.

Meanwhile, the patterns 320 may be disposed to be spaced apart from each other. That is, the patterns 320 may be disposed to be spaced apart from each other so that one surface of the substrate 310 is exposed between the patterns 320.

For example, a separation distance d between the patterns 320 may be about 2 μm to about 4 μm. When the patterns 320 are disposed to be spaced apart by less than about 2 μm, the patterns 320 may overlap each other to form sizes of the patterns 320 having an undesired size. In addition, when the patterns 320 are disposed to be spaced apart by exceeding about 4 μm, the size of the substrate 310 is increased due to the separation distance between the patterns 320, thereby increasing the overall size of the optical path control member.

As the patterns 320 are disposed to be spaced apart from each other, a pattern region PA in which the patterns 320 are disposed and a non-pattern region NPA in which the patterns are not disposed may be formed on the substrate 310.

In this case, the pattern region PA and the non-pattern region NPA may be formed in a certain area. For example, a size of the pattern region PA may be about 43% to about 60% with respect to an entire area. Also, a size of the non-pattern region NPA may be about 40% to 57% of the entire area.

The size of the pattern region PA and the size of the non-pattern region NPA are sizes for maximizing the amount of light that passes through the pattern layer and is incident inside the resin layer, and when the sizes are out of the range, the light transmittance is reduced and the overall brightness of the optical path control member may be lowered.

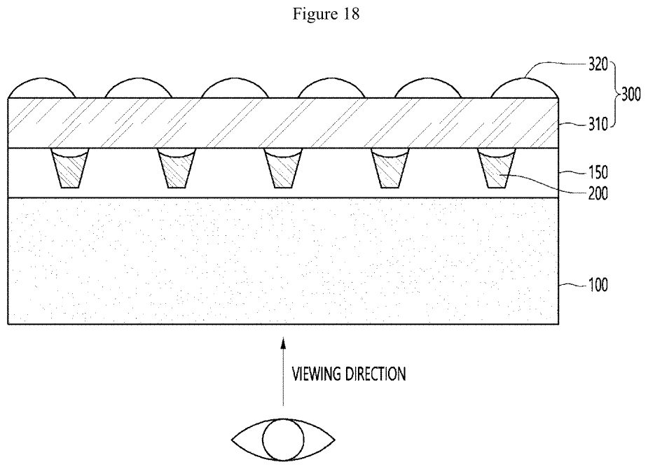

Meanwhile, referring to FIGS. 18 to 20, the pattern layer may be disposed at various positions.

Referring to FIG. 18, the pattern layer 300 may be disposed on an upper surface of the resin layer 150. That is, the substrate 310 may be disposed on the upper surface of the resin layer 150, and a plurality of patterns 320 may be disposed on the substrate 310.

That is, the pattern layer 300 may be disposed on a surface opposite to the surface on which the user looks at the optical path control member.

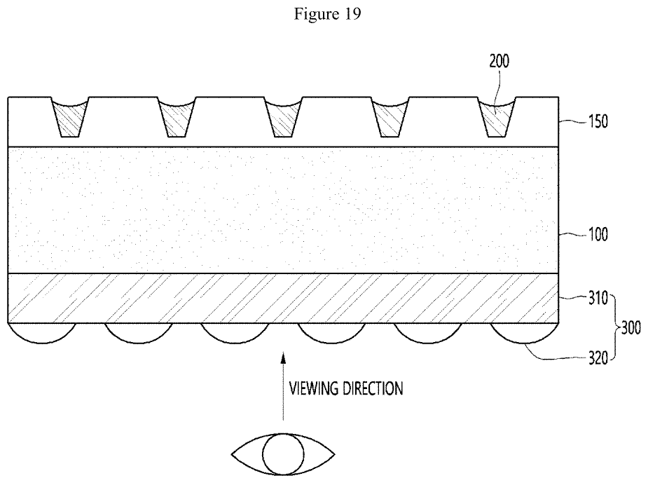

Alternatively, referring to FIG. 19, the pattern layer 300 may be disposed on a lower surface of the resin layer 150. That is, the pattern layer 300 may be disposed on one surface of the base substrate 100. In detail, the substrate 310 may be disposed on one surface of the base substrate 100, and the plurality of patterns 320 may be disposed on the substrate 310.

That is, the pattern layer 300 may be disposed on a surface on which the user looks at the optical path control member.

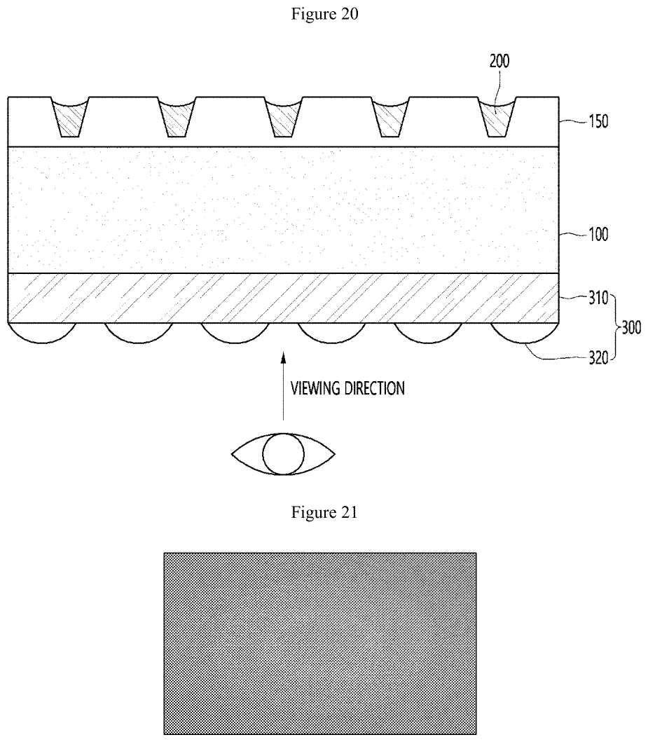

Alternatively, referring to FIG. 20, the substrate is omitted in the pattern layer 300, and only the patterns 320 may be disposed on the resin layer 150. That is, the resin layer 150 may serve as a supporting substrate supporting the patterns. Accordingly, it is possible to reduce the size of the optical path control member and improve transmittance by omitting a separate substrate for supporting the patterns.

Hereinafter, the present invention will be described in more detail through observation of the moire of the optical path control member according to Examples and Comparative Examples. These Examples are merely illustrative to describe the present invention in more detail. Therefore, the present invention is not limited thereto.

### Example 4-1

After a UV resin was disposed on a polyethylene terephthalate substrate, a plurality of engraved portions and a plurality of embossed portions disposed between the plurality of engraved portions were formed on the UV resin by an imprinting process.

Subsequently, black ink was filled by screen printing inside the plurality of engraved portions to form a pattern portion inside the engraved portions.

Subsequently, black ink adhering to regions other than the engraved portions was removed to manufacture a final optical path control member.

Subsequently, the optical path control member was positioned on a display panel, and a pattern layer including a plurality of hemispherical patterns was disposed between the display panel and the optical path control member.

At this time, a diameter of the pattern was 15 μm.

Subsequently, a moire phenomenon was observed on an upper surface of the substrate.

### Example 4-2

Except that the patterns had different diameters of 5 μm and 15 μm, after forming the optical path control member in the same manner as in Example 4-1, the moire phenomenon was observed on the upper surface of the substrate.

### Comparative Example 1

Except that the pattern layer was not disposed, after forming the optical path control member in the same manner as in Example 4-1, the moire phenomenon was observed on the upper surface of the substrate.

### Comparative Example 2

Except that the diameters of the patterns were 30 μm, after forming the optical path control member in the same manner as in Example 4-2, the moire phenomenon was observed on the upper surface of the substrate.

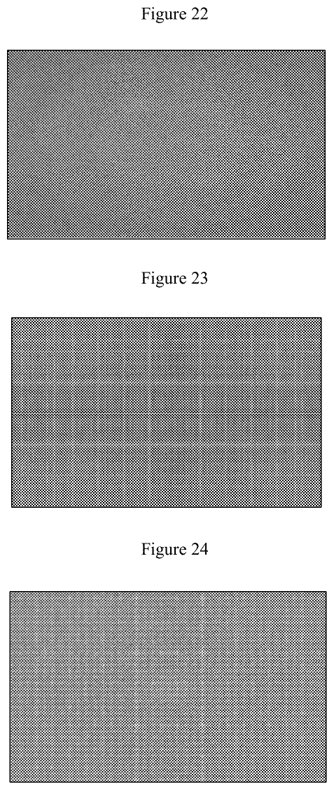

FIG. 21 is a photograph of Example 4-1, FIG. 22 is a photograph of Example 4-2, FIG. 23 is a photograph of Comparative Example 1, and FIG. 24 is a photograph of Comparative Example 2.

Referring to FIGS. 21 to 24, it can be seen that a shape of the patterns is hardly recognized from the outside in the optical path control member according to Examples.

That is, it can be seen that the optical path control member of the Examples in which the diameters of the patterns are controlled to be less than a certain size and the diameters of the patterns are controlled to be different, the shape of the patterns is not visually recognized from the outside, thereby improving visibility.

On the other hand, in the optical path control member according to Comparative Examples, it can be seen that patterns are visually recognized from the outside.

That is, when there are no patterns or the diameter of the patterns exceeds a certain size, it can be seen that the shape of the patterns is visually recognized from the outside, thereby deteriorating visibility.

The optical path control member according to the fourth embodiment may prevent a moire phenomenon that occurs when a pattern serving as a light absorbing portion overlaps patterns of a light source member coupled to the optical path control member.

That is, a regular pattern due to overlapping of the pattern of the optical path control member and the pattern of the display panel is randomly dispersed by disposing the pattern layer between the pattern of the optical path control member and the pattern of the display panel, or by disposing another additional pattern layer on the optical path control member, and accordingly, the moire phenomenon caused by overlapping of the regular pattern may be minimized.

Therefore, the optical path control member according to the fourth embodiment improve visibility of the optical path control member and a display device coupled thereto by minimizing the moire phenomenon.

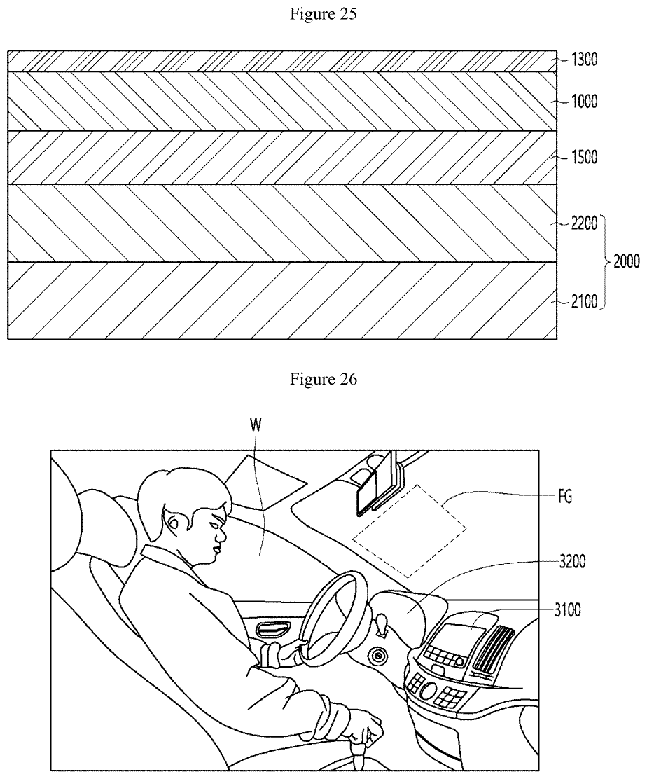

Hereinafter, referring to FIGS. 25 and 26, a display device and a display device to which an optical path control member according to an embodiment is applied will be described.

Referring to FIG. 25, an optical path control member 1000 according to an embodiment may be disposed on a display panel 2000.

The optical path control member 1000 may be disposed to be adhered to the display panel. In detail, the resin layer 150 of the optical path control member 1000 and the display panel may be adhered to each other. For example, the optical path control member 1000 and the display panel 2000 may be adhered to each other through an adhesive layer 1500 that transmits light. For example, the display panel and the optical path control member 1000 may be adhered to each other via an adhesive layer 1500. The adhesive layer 1500 may be transparent. For example, the adhesive layer 1500 may include an adhesive or an adhesive layer including an optical transparent adhesive material.

The adhesive layer 1500 may include a release film. Specifically, the adhesive layer may be disposed while covering the pattern portion on a resin layer 150 of the optical path control member, and when the adhesive layer adheres to the pattern layer or the display panel, after the release film is removed, the pattern layer, the optical path control member, and the display panel may be adhered to each other.

Accordingly, when the pattern portion is exposed to the outside by the adhesive layer 1500, a risk of breakage may be prevented. That is, the adhesive layer 1500 may be an adhesive layer and a protective layer.

The display panel 2000 may include a first substrate 2100 and a second substrate 2200. When the display panel 2000 is a liquid crystal display panel, the display panel 2000 may be formed in a structure in which a first substrate 2100 including a thin film transistor (TFT) and a pixel electrode and a second substrate 2200 including color filter layers are bonded with a liquid crystal layer interposed therebetween.

In addition, the display panel 2000 may be a liquid crystal display panel of a color filter on transistor (COT) structure in which a thin film transistor, a color filter, and a black matrix are formed at a first substrate 2100 and a second substrate 2200 is bonded to the first substrate 2100 with a liquid crystal layer interposed therebetween. That is, a thin film transistor may be formed on the first substrate 2100, a protective film may be formed on the thin film transistor, and a color filter layer may be formed on the protective film. In addition, a pixel electrode in contact with the thin film transistor may be formed on the first substrate 2100. At this point, in order to improve an aperture ratio and simplify a masking process, a black matrix may be omitted, and a common electrode may be formed to function as the black matrix.

In addition, when the display panel 2000 is a liquid crystal display panel, the display device may further include a backlight unit providing light from a rear surface of the display panel 2000.

Alternatively, when the display panel 2000 is an organic electroluminescence display panel, the display panel 2000 may include a self-luminous element that does not require a separate light source. In the display panel 2000, a thin film transistor may be formed on the first substrate 2100, and an organic light-emitting element in contact with the thin film transistor may be formed. The organic light-emitting element may include an anode, a cathode, and an organic light-emitting layer formed between the anode and the cathode. Further, a second substrate 2200 serving as an encapsulation substrate for encapsulation may further be included on the organic light-emitting element.

In addition, although not shown in drawings, a polarizing plate may be further disposed between the optical path control member 1000 and the display panel 2000. The polarizing plate may be a linear polarizing plate or an external light reflection preventive polarizing plate. For example, when the display panel 2000 is a liquid crystal display panel, the polarizing plate may be the linear polarizing plate. Further, when the display panel 2000 is an organic electroluminescence display panel, the polarizing plate may be the external light reflection preventive polarizing plate.

In addition, an additional functional layer 1300 such as an anti-reflection layer, an anti-glare, or the like may be further disposed on the optical path control member 1000. Specifically, the functional layer 1300 may be adhered to one surface of the base substrate 100 of the optical path control member. Although not shown in drawings, the functional layer 1300 may be adhered to the base 100 of the optical path control member via an adhesive layer. In addition, a release film for protecting the functional layer may be further disposed on the functional layer 1300.

Further, a touch panel may be further disposed between the display panel and the optical path control member.

Although it is shown in the drawings that the optical path control member is disposed at an upper portion of the display panel, but the embodiment is not limited thereto, and the optical path control member may be disposed at various positions such as a position in which light is adjustable, that is, a lower portion of the display panel, between an upper substrate and a lower substrate of the display panel, or the like.

Referring to FIG. 26, an optical path control member according to an embodiment may be applied to a vehicle.

Referring to FIG. 26, a display device to which the optical path control member according to the embodiment is applied may be disposed inside a vehicle.

For example, the display device according to the embodiment may display a video confirming information of the vehicle and a movement route of the vehicle. The display device 3100 may be disposed between a driver seat and a passenger seat of the vehicle.

In addition, the optical path control member according to the embodiment may be applied to a dashboard 3200 that displays a speed, an engine, an alarm signal, and the like of the vehicle.

Further, the optical path control member according to the embodiment may be applied to a windshield (FG) of the vehicle or right and left window glasses (W).

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

The above description of the embodiments is merely examples and does not limit the present invention. It would be apparent to those of ordinary skill in the art that the present invention may be easily embodied in many different forms without changing the technical idea or essential features thereof. For example, elements of the exemplary embodiments described herein may be modified and realized. Also, it should be construed that differences related to such changes and applications are included in the scope of the present invention defined in the appended claims.

1. An optical path control member comprising:
a base substrate;
a resin layer disposed on the base substrate and including a plurality of engraved portions spaced apart from each other; and
a plurality of pattern portions disposed inside the plurality of engraved portions and spaced apart from each other,
wherein each pattern portion includes a first light shielding layer and a second light shielding layer disposed on the first light shielding layer,
a height of the first light shielding layer is larger than a height of the second light shielding layer,
a first material forming the first light shielding layer has a lower viscosity than a second material forming the second light shielding layer, and
a total height of each pattern portion is equal to or less than a total height of the engraved portion, and is 93% or more of a height of the engraved portion.

2. The optical path control member of claim 1, wherein
a first distance between the highest point and the lowest point of an upper surface of the first light shielding layer is defined,
a second distance between the highest point and the lowest point of an upper surface of the second light shielding layer is defined, and
the second distance is smaller than the first distance.

3. The optical path control member of claim 1, wherein the plurality of pattern portions include a first pattern portion and a second pattern portion that are adjacent to each other and spaced apart from each other,
a first-first distance that is a height deviation between the highest point and the lowest point of an upper surface of the first pattern portion is defined,
a first-second distance that is a height deviation between the highest point and the lowest point of an upper surface of the second pattern portion is defined, and
a difference in magnitude between the first-first distance and the first-second distance is 1 μm or less.

4. The optical path control member of claim 1, comprising
a pattern layer disposed on one surface or the other surface of the resin layer,
wherein the pattern layer includes a plurality of patterns, and
a diameter of each pattern is 15 μm or less.

5. An optical path control member comprising:
a base substrate;
a resin layer disposed on the base substrate and including a plurality of engraved portions spaced apart from each other; and
a plurality of pattern portions disposed inside the plurality of engraved portions and spaced apart from each other,
wherein a width of the pattern portion is defined as a first distance, a distance between the pattern portions is defined as a second distance, and a height of the pattern portion is defined as a third distance,
the first distance is 1 μm to 10 μm,
the third distance is 20 μm to 120 μm, and
the optical path control member satisfies Equation 1 and Equation 2 below:
Second distance/(First distance+Second distance)≥0.75 [Equation 1]
Second distance/Third distance<0.32. [Equation 2]

6. The optical path control member of claim 5, wherein when defining a viewing angle of a user looking at a lower surface of the resin layer as 0°,
light transmittance from 0° to 60° is 60% or more, and
light transmittance from over 60° to 90° is 1% or less.

7. An optical path control member comprising:
a base substrate;
a resin layer disposed on the base substrate and including a plurality of engraved portions and a plurality of embossed portions spaced apart from each other; and
a plurality of pattern portions disposed inside the plurality of engraved portions and spaced apart from each other,
wherein the pattern portion blocks light, and the embossed portion transmits light,
a refractive index of the embossed portion is larger than a refractive index of the pattern portion,
the refractive index of the embossed portion is 1.54 to 1.64,
a difference between the refractive index of the embossed portion and the refractive index of the pattern portion is 0.1 to 0.16, and
a critical angle at an interface between the pattern portion and the embossed portion is 63° to 79°.

8. The optical path control member of claim 7, wherein a width of the pattern portion is 1 μm to 10 μm,
a height of the pattern portion is 20 μm to 120 μm.

9. The optical path control member of claim 7, wherein the refractive index of the pattern portion is 1.47 to 1.51.

10. The optical path control member of claim 7, wherein the resin layer includes a lower surface in contact with the base substrate and an upper surface opposite to the lower surface,
incident light is incident on the upper surface, and emitted light is emitted toward the lower surface, and
transmittance of the emitted light with respect to 100% of the incident light is 65% or more.

11. The optical path control member of claim 1, wherein light transmittance of the first light shielding layer is smaller than light transmittance of the second light shielding layer.

12. The optical path control member of claim 1, comprising
a third light shielding layer disposed on the second light shielding layer,
wherein a third material forming the third light shielding layer has a higher viscosity than the first material and the second material.

13. The optical path control member of claim 11, comprising
a third light shielding layer disposed on the second light shielding layer,
wherein light transmittance of the third light shielding layer is greater than the light transmittance of the first light shielding layer and the light transmittance of the second light shielding layer.

14. The optical path control member of claim 1, wherein a height of the pattern portion is equal to or less than the height of the engraved portion.
